(19) United States
(12) Patent Application Publication
(10) Pub. No.: US 2022/0247780 A1
(43) Pub. Date: Aug. 4, 2022

(54) INFORMATION PROCESSING APPARATUS, INFORMATION PROCESSING METHOD, AND COMPUTER READABLE MEDIUM

(71) Applicant: Mitsubishi Electric Corporation, Tokyo (JP)

(72) Inventors: Takumi MORI, Tokyo (JP); Tadakazu YAMANAKA, Tokyo (JP); Masahiro FUJITA, Tokyo (JP)

(73) Assignee: Mitsubishi Electric Corporation, Tokyo (JP)

(21) Appl. No.: 17/721,731

(22) Filed: Apr. 15, 2022

Related U.S. Application Data
(63) Continuation of application No. PCT/JP2019/050137, filed on Dec. 20, 2019.

(51) Int. Cl. H04L 9/40

(52) U.S. Cl. CPC H04L 63/1466; H04L 63/062; H04L 63/1433

(57) ABSTRACT

An evaluation-value acquisition unit (102) acquires an evaluation value regarding information security of an evaluated supplier which has been evaluated regarding the information security. A number-of-appearances acquisition unit (105) acquires the number of appearances as to the evaluated supplier of each of two or more keywords regarding the information security in public information. A model generation unit (106) performs multiple regression analysis using the evaluation value of the evaluated supplier and the number of appearances as to the evaluated supplier of each of the two or more keywords in the public information, and generates a regression model whose explanatory variable is the number of appearances of each of the two or more keywords in the public information and whose object variable is the evaluation value.

### CROSS REFERENCE TO RELATED APPLICATIONS

This application is a Continuation of PCT International Application No. PCT/JP2019/050137, filed on Dec. 20, 2019, which is hereby expressly incorporated by reference into the present application.

### TECHNICAL FIELD

The present disclosure relates to evaluation of an information security level of a supplier.

### BACKGROUND ART

Due to spread of IoT (Internet of Things), support from a supplier is necessary for developing a product or a service. Therefore, a safe and secure supply chain is required to be formed. The supply chain is a flow of a series of business activities from a raw material to bringing a product or a service to a consumer.

A cyber-attack which abuses the supply chain is called a supply chain attack. In the supply chain attack, for example, malware or a backdoor is embedded in IT equipment or software in a manufacturing stage at a supplier. Further, the malware or the backdoor is also embedded in an update program or a patch from a supplier.

In order to avoid the supply chain attack, a buyer also needs to pay attention to an information security level of the supplier (hereinafter, also referred to as “security level”). Further, the buyer needs to take measures such as dealing only with a supplier whose information security level is at a required level, and requesting for improvement, a supplier whose information security level is not at the required level.

Patent Literature 1 discloses a technique that can easily acquire useful information regarding security by evaluating an information source of information regarding a security incident.

### CITATION LIST

### Patent Literature

Patent Literature 1: WO2004/075137

### SUMMARY OF INVENTION

### Technical Problem

In a technique of Patent Literature 1, an information source of information regarding a security incident is evaluated. The security incident is an incident that can lead to a security problem including a cyber-attack, an unauthorized access, and the like. Then, in the technique of Patent Literature 1, information which is useful for dealing with the security incident is acquired by evaluating the information source.

As described above, when the security incident occurs, the technique of Patent Literature 1 can only collect information which is for dealing with the security incident.

As described above, in order to avoid the supply chain attack, the buyer needs to recognize the information security level of the supplier. However, there is a problem that the technique of Patent Literature 1 cannot acquire the evaluation regarding the information security of the supplier.

One of the main purposes of the present disclosure is to solve the above-described problem. More specifically, the main purpose of the present disclosure is to realize a configuration that can acquire an evaluation regarding information security of a supplier.

### Solution to Problem

An information processing apparatus according to the present disclosure includes:

an evaluation-value acquisition unit to acquire an evaluation value regarding information security of an evaluated supplier which has been evaluated regarding the information security;

a number-of-appearances acquisition unit to acquire the number of appearances as to the evaluated supplier of each of two or more keywords regarding the information security in public information; and

a model generation unit to perform multiple regression analysis using the evaluation value of the evaluated supplier and the number of appearances as to the evaluated supplier of each of the two or more keywords in the public information, and generate a regression model whose explanatory variable is the number of appearances of each of the two or more keywords in the public information and whose object variable is the evaluation value.

### Advantageous Effects of Invention

According to the present disclosure, it is possible to acquire evaluation regarding information security of a supplier.

### BRIEF DESCRIPTION OF DRAWINGS

FIG. 1 is a diagram illustrating a configuration example of a security level verification system according to a first embodiment.

FIG. 2 is a diagram illustrating a hardware configuration example of an information processing apparatus according to the first embodiment.

FIG. 3 is a diagram illustrating a functional configuration example of the information processing apparatus according to the first embodiment.

FIG. 4 is a flowchart illustrating an operation example of the information processing apparatus in a model generation phase according to the first embodiment.

FIG. 5 is a diagram illustrating an example of an evaluation value and the number of appearances of a key word for each supplier according to the first embodiment.

FIG. 6 is a flowchart illustrating an operation example of the information processing apparatus in an evaluation-value calculation phase according to the first embodiment.

FIG. 7 is a flowchart illustrating an example of an evaluation calculation process of the information processing apparatus according to the first embodiment.

FIG. 8 is a flowchart illustrating an operation example of an information processing apparatus in a model generation phase according to a third embodiment.

### DESCRIPTION OF EMBODIMENTS

Hereinafter, embodiments will be described with reference to the drawings.

In the following description of the embodiments and the drawings, parts assigned by the same reference numerals indicate the same parts or corresponding parts.

### First Embodiment

***Description of Configuration***

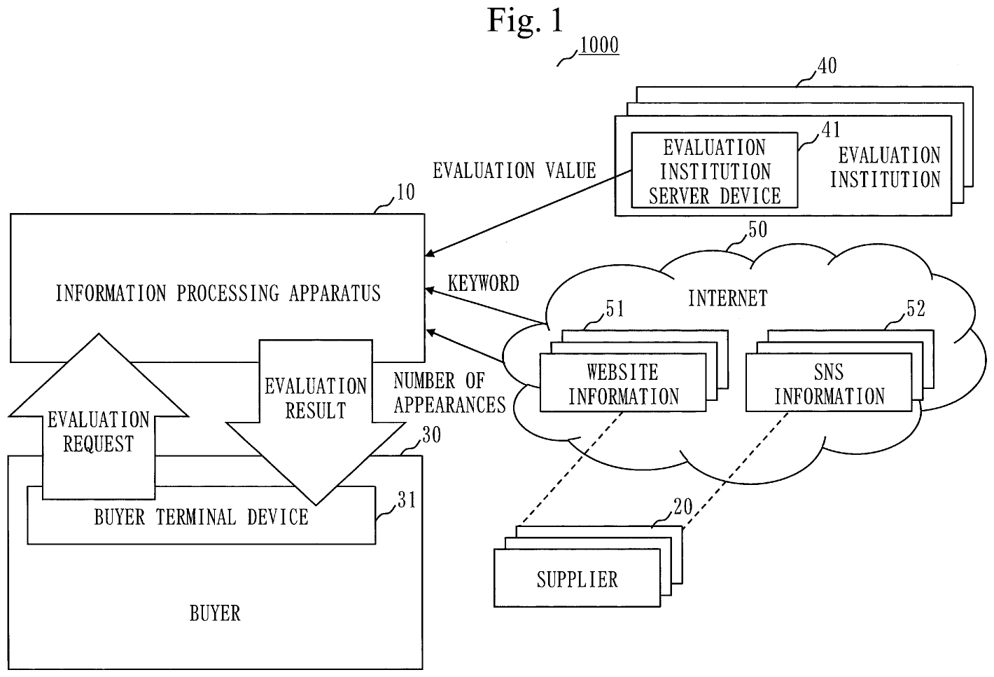

FIG. 1 illustrates a configuration example of a security level verification system 1000 according to the present embodiment.

An information processing apparatus 10 evaluates an information security level of a supplier 20 according to an evaluation request from a buyer 30.

The information processing apparatus 10 is a computer. An operation procedure of the information processing apparatus 10 is equivalent to an information processing method. Further, a program that realizes operation of the information processing apparatus 10 is equivalent to an information processing program.

The information processing apparatus 10 is placed in, for example, a security level verification institution.

The supplier 20 is a different company from the buyer 30.

The supplier 20 is a company which supplies to the buyer 30, an item used for a product or a service of the buyer 30. The item that the supplier 20 supplies to the buyer 30 is referred to as a supply item.

The supply item is any tangible or intangible object, such as a raw material, a constituent, a semi-finished product, manufacturing equipment, packaging, a container, a tool or software, which is used for the product or the service of the buyer 30.

It does not matter whether the supplier 20 has already started supplying the supply item to the buyer 30 or the supplier 20 has not yet started supplying the supply item to the buyer 30. That is, it is acceptable that the supplier 20 is a potential business counterpart for the buyer 30.

The buyer 30 is a company to which the supplier 20 supplies the supply item.

As described above, it does not matter whether the buyer 30 has already started being supplied the supply item from the supplier 20 or the buyer 30 has not yet started being supplied the supply item from the supplier 20.

In the buyer 30, a buyer terminal device 31 operates. The buyer terminal device 31 is a computer.

An evaluation institution 40 performs evaluation regarding the information security level of the supplier 20, and calculates an evaluation value.

A plurality of evaluation institutions 40 exist.

An evaluation institution server device 41 is placed in each evaluation institution 40. The evaluation institution server device 41 transmits the evaluation value to the information processing apparatus 10.

Internet 50 includes website information 51 and SNS information 52. The website information 51 and the SNS information 52 are examples of public information. Note that, the public information is not limited to the website information 51 and the SNS information 52, and the public information may be any open information on the Internet 50.

The website information 51 includes, for example, news on a news website, security-related information on a security-related website, a product review on an E-commerce website, product information on a supplier 20's own website, and the like. Further, the website information 51 may include incident-case information from a public institution.

The SNS information 52 is information shared on a SNS (Social Networking Service). The SNS is a community-form information sharing service.

Below, the website information 51 and the SNS information 52 may be collectively referred to as the public information.

Here, with reference to FIG. 1, an outline of the security level verification system 1000 according to the present embodiment will be described.

Each evaluation institution 40 performs the evaluation regarding the information security of the supplier 20, and calculates the evaluation value.

Note that, in the present embodiment, it is assumed that each evaluation institution 40 has evaluated some of a plurality of suppliers 20, but has not evaluated the rest of the suppliers 20.

Below, the supplier 20 that has been evaluated by one of the evaluation institutions 40 is referred to as an evaluated supplier 20. Further, the supplier 20 that has not been evaluated by any evaluation institution 40 is referred to as an unevaluated supplier 20.

The evaluation value calculated by the evaluation institution 40 is stored in the evaluation institution server device 41.

On the Internet 50, news regarding the supplier 20, a product review regarding the supply item from the supplier 20, and the like are generated as the website information 51. Further, information regarding the supply item from the supplier 20 is generated as the SNS information 52.

An operation phase of the information processing apparatus 10 has a model generation phase and an evaluation-value calculation phase.

In the model generation phase, the information processing apparatus 10 acquires the evaluation value of the evaluated supplier 20 from the evaluation institution server device 41.

Further, the information processing apparatus 10 analyzes, for example, security-related information on a security-related website, being the website information 51, and selects a plurality of keywords regarding the information security.

Further, the information processing apparatus 10 investigates the website information 51 and the SNS information 52, and acquires the number of appearances as to the evaluated supplier 20 of each keyword.

Further, the information processing apparatus 10 performs multiple regression analysis using the evaluation value of the evaluated supplier 20 acquired from the evaluation institution server device 41, and the number of appearances as to the evaluated supplier 20 of the keywords acquired from the website information 51 and the SNS information 52, and generates a regression model.

More specifically, the information processing apparatus 10 generates a regression model whose explanatory variable is the number of appearances of the keyword and whose objective variable is the evaluation value.

In the evaluation-value calculation phase, first, the buyer terminal device 31 issues an evaluation request to the information processing apparatus 10. More specifically, the buyer terminal device 31 issues the evaluation request, and requests the information processing apparatus 10 to calculate the evaluation value regarding the information security of the unevaluated supplier 20.

Upon issuance of the evaluation request, the information processing apparatus 10 investigates the website information 51 and the SNS information 52, and acquires the number of appearances of a keyword, as to the unevaluated supplier 20 (hereinafter, referred to as an evaluation-subject supplier 20) which is subject to the evaluation.

Next, the information processing apparatus 10 applies to the regression model, the acquired number of appearances as to the evaluation-subject supplier 20 of the keyword, and calculates the evaluation value of the evaluation-subject supplier 20.

Then, the information processing apparatus 10 transmits the evaluation value of the evaluation-subject supplier 20 to the buyer terminal device 31 as an evaluation result.

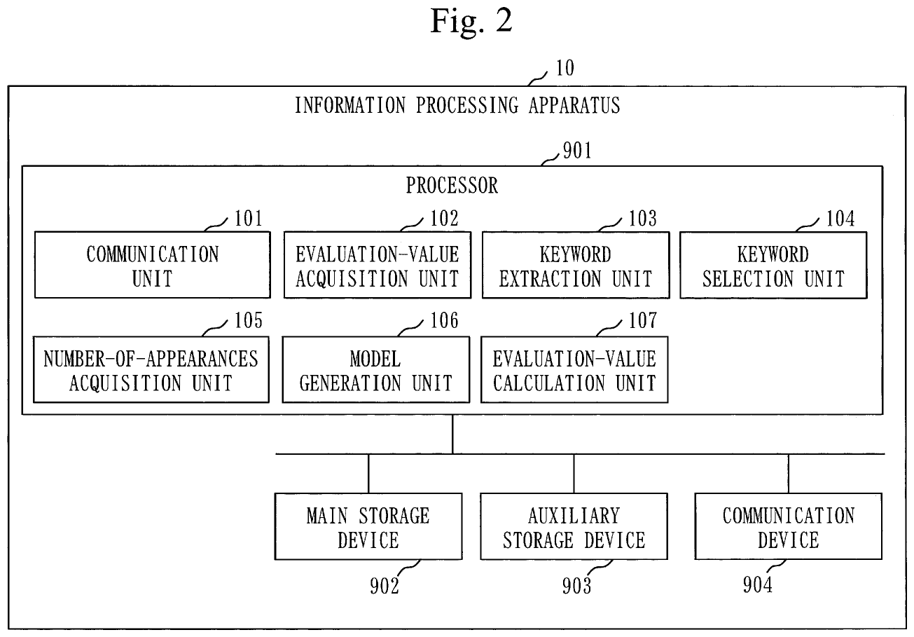

Next, with reference to FIG. 2, a hardware configuration example of the information processing apparatus 10 will be described.

FIG. 2 illustrates the hardware configuration example of the information processing apparatus 10.

The information processing apparatus 10 includes a processor 901, a main storage device 902, an auxiliary storage device 903, and a communication device 904 as pieces of hardware.

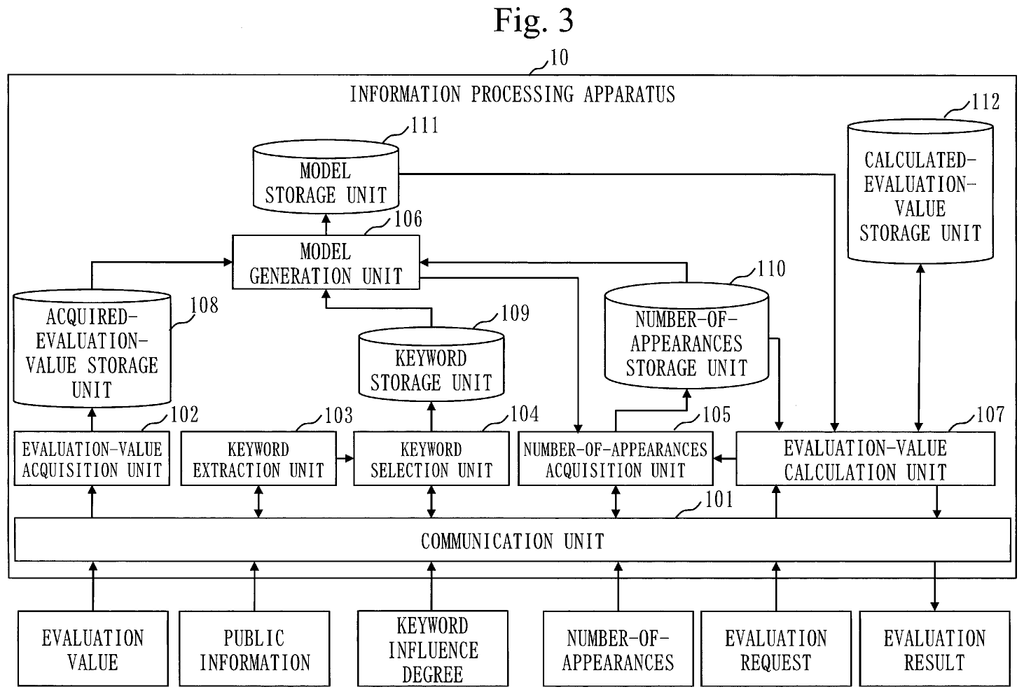

Further, the information processing apparatus 10 includes as a functional configuration, a communication unit 101, an evaluation-value acquisition unit 102, a keyword extraction unit 103, a keyword selection unit 104, a number-of-appearances acquisition unit 105, a model generation unit 106, an evaluation-value calculation unit 107, an acquired-evaluation-value storage unit 108, a keyword storage unit 109, a number-of-appearances storage unit 110, a model storage unit 111, and a calculated-evaluation-value storage unit 112 which are illustrated in FIG. 3. Details of the communication unit 101, the evaluation-value acquisition unit 102, the keyword extraction unit 103, the keyword selection unit 104, the number-of-appearances acquisition unit 105, the model generation unit 106, the evaluation-value calculation unit 107, the acquired-evaluation-value storage unit 108, the keyword storage unit 109, the number-of-appearances storage unit 110, the model storage unit 111, and the calculated-evaluation-value storage unit 112 will be described later.

In the auxiliary storage device 903, programs that realize functions of the communication unit 101, the evaluation-value acquisition unit 102, the keyword extraction unit 103, the keyword selection unit 104, the number-of-appearances acquisition unit 105, the model generation unit 106, and the evaluation-value calculation unit 107 are stored.

These programs are loaded from the auxiliary storage device 903 into the main storage device 902. Then, the processor 901 executes these programs, and performs operation of the communication unit 101, the evaluation-value acquisition unit 102, the keyword extraction unit 103, the keyword selection unit 104, the number-of-appearances acquisition unit 105, the model generation unit 106, and the evaluation-value calculation unit 107 which will be described later.

FIG. 2 schematically illustrates a state where the processor 901 executes the programs that realize the functions of the communication unit 101, the evaluation-value acquisition unit 102, the keyword extraction unit 103, the keyword selection unit 104, the number-of-appearances acquisition unit 105, the model generation unit 106, and the evaluation-value calculation unit 107.

Further, the acquired-evaluation-value storage unit 108, the keyword storage unit 109, the number-of-appearances storage unit 110, the model storage unit 111, and the calculated-evaluation-value storage unit 112 are realized by the main storage device 902 or the auxiliary storage device 903.

Next, with reference to FIG. 3, a functional configuration example of the information processing apparatus 10 will be described.

FIG. 3 illustrates the functional configuration example of the information processing apparatus 10.

The communication unit 101 performs communication with an outside device.

More specifically, the communication unit 101, for example, receives the evaluation value of the evaluated supplier 20 from the evaluation institution server device 41 placed in the evaluation institution 40.

Further, the communication unit 101, for example, acquires the public information such as the website information 51 and the SNS information 52, an influence degree of the keyword, and the number of appearances of the keyword, from a server device on the Internet 50.

Further, the communication unit 101 receives the evaluation request from the buyer terminal device 31, and transmits the evaluation result to the buyer terminal device 31.

The evaluation-value acquisition unit 102 acquires the evaluation value of the evaluated supplier 20 via the communication unit 101. The evaluation-value acquisition unit 102 stores the acquired evaluation value in the acquired-evaluation-value storage unit 108.

A process performed by the evaluation-value acquisition unit 102 is equivalent to an evaluation-value acquisition process.

The keyword extraction unit 103 acquires the public information via the communication unit 101, and extracts from the acquired public information, keywords which frequently appear. More specifically, the keyword extraction unit 103 extracts three or more keywords.

Then, the keyword extraction unit 103 stores the extracted three or more keywords in the acquired-evaluation-value storage unit 108.

The keyword selection unit 104 acquires the three or more keywords from the keyword extraction unit 103, investigates the influence degree of each keyword in the public information via the communication unit 101, and acquires the influence degree of each keyword via the communication unit 101.

Then, the keyword selection unit 104 selects two or more keywords from among the three or more keywords based on the influence degree.

The keyword selection unit 104 stores the selected two or more keywords in the keyword storage unit 109.

The number-of-appearances acquisition unit 105 acquires via the communication unit 101, the number of appearances as to the evaluated supplier 20 of each of the two or more keywords selected by the keyword selection unit 104 in the public information.

Further, the number-of-appearances acquisition unit 105 acquires via the communication unit 101, the number of appearances as to the evaluation-subject supplier 20 of each of the two or more keywords in the public information.

Then, the number-of-appearances acquisition unit 105 stores the acquired numbers of appearances in the number-of-appearances storage unit 110.

A process performed by the number-of-appearances acquisition unit 105 is equivalent to a number-of-appearances acquisition process.

The model generation unit 106 performs the multiple regression analysis using the evaluation value of the evaluated supplier 20 and the number of appearances as to the evaluated supplier 20 of each of the two or more keywords in the public information, and generates the regression model. The regression model is a model whose explanatory variable is the number of appearances of each of the two or more keywords in the public information and whose object variable is the evaluation value.

A process performed by the model generation unit 106 is equivalent to a model generation process.

The evaluation-value calculation unit 107 calculates the evaluation value when the evaluation-value calculation unit 107 acquires via the communication unit 101 from the buyer terminal device 31, the evaluation request as to the unevaluated supplier 20. That is, the evaluation-value calculation unit 107 applies to the regression model, the number of appearances as to the evaluation-subject supplier 20 of each of the two or more keywords in the public information, and calculates the evaluation value of the evaluation-subject supplier 20.

Then, the evaluation-value calculation unit 107 transmits to the buyer terminal device 31 via the communication unit 101, the evaluation value as an evaluation result.

The acquired-evaluation-value storage unit 108 stores the evaluation value of the evaluated supplier 20 acquired by the evaluation-value acquisition unit 102.

The keyword storage unit 109 stores the two or more keywords selected by the keyword selection unit 104.

The number-of-appearances storage unit 110 stores the numbers of appearances as to the evaluated supplier 20 of the keywords, and the numbers of appearances as to the evaluation-subject supplier 20 of the keywords, both acquired by the number-of-appearances acquisition unit 105.

The model storage unit 111 stores the regression model generated by the model generation unit 106.

The calculated-evaluation-value storage unit 112 stores the evaluation value calculated by the evaluation-value calculation unit 107.

***Description of Operation***

Next, an operation example of the information processing apparatus 10 according to the present embodiment will be described.

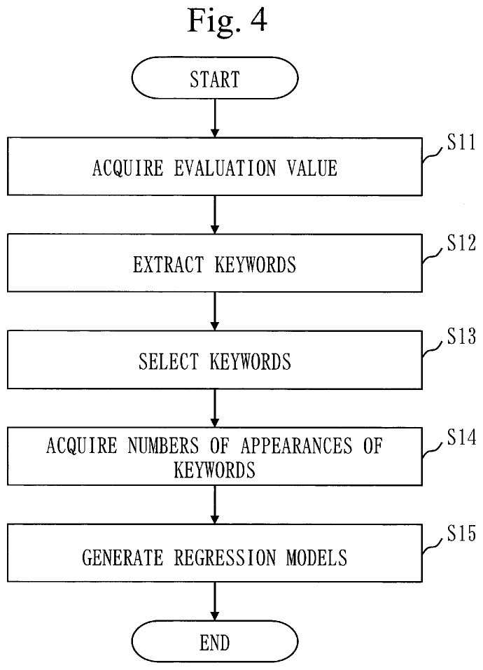

FIG. 4 illustrates the operation example of the information processing apparatus 10 in the model generation phase according to the present embodiment.

In step S11, the model generation unit 106 decides the supplier 20 to be used in learning for generating the regression model. Specifically, the model generation unit 106 decides the supplier 20 to be used in the learning from among the evaluated suppliers 20. For example, it is assumed that the model generation unit 106 is periodically notified of a name of the evaluated supplier 20 newly evaluated, by each evaluation institution 40.

Then, the model generation unit 106 instructs the evaluation-value acquisition unit 102 to acquire the evaluation value of the evaluated supplier 20 decided which is subject to the learning.

The evaluation-value acquisition unit 102 receives via the communication unit 101 from the evaluation institution server device 41 of each evaluation institution 40, the evaluation value of the evaluated supplier 20 which is subject to the learning. Then, the evaluation-value acquisition unit 102 stores the received evaluation value in the acquired-evaluation-value storage unit 108.

In step S12, the keyword extraction unit 103 extracts the keywords.

More specifically, the keyword extraction unit 103, for example, analyzes security-related information on a security-related website, and extracts frequently-appeared keywords regarding the information security. The keyword extraction unit 103 may extract the frequently-appeared keywords also from a news website. Furthermore, the keyword extraction unit 103 may perform morphological analysis on latest news, and derives the frequently-appeared keywords from keyword distribution.

Finally, the keyword extraction unit 103 extracts three or more keywords.

The keyword extraction unit 103 outputs the extracted keywords to the keyword selection unit 104.

Note that, the order of step S11 and step S12 is swappable. Further, step S11 and step S12 may be performed simultaneously.

In step S13, the keyword selection unit 104 selects two or more keywords from the three or more keywords extracted by the keyword extraction unit 103. For example, the keyword selection unit 104 selects the keywords based on the influence degree of each key word. Specifically, the keyword selection unit 104 acquires the influence degree of each keyword according to a procedure below.

The keyword selection unit 104 searches a news website for each keyword and a name of the evaluated supplier 20 which is subject to the learning. Then, the keyword selection unit 104 collects for each keyword, news that presents the keyword and the name of the evaluated supplier 20 which is subject to the learning.

Further, the keyword selection unit 104 investigates “display order” and “the number of hits” on a search engine, using a headline of the collected news as a search word. Further, the keyword selection unit 104 investigates for each keyword, the number of times of the headline of the collected news becomes a topic in the SNS information 52. Then, the keyword selection unit 104 selects keywords which have high “display order” on a search engine, the high “number of hits” on the search engine, and the high number of times of a topic in the SNS information 52.

The keyword selection unit 104 stores the selected two or more keywords in the keyword storage unit 109.

Since the keyword selection unit 104 selects the keywords according to the above-described procedure, the keyword selection unit 104 can select truly influential keywords even if a particular supplier 20 concocts information to their advantage.

Next, in step S14, the number-of-appearances acquisition unit 105 acquires the number of appearances of each keyword, as to the evaluated supplier 20 which is subject to the learning.

Specifically, the model generation unit 106 reads the two or more keywords from the keyword storage unit 109, and notifies the number-of-appearances acquisition unit 105 of the two or more read keywords and the name of the evaluated supplier 20 which is subject to the learning.

For each keyword, the number-of-appearances acquisition unit 105 uses as search words, the keyword and the name of the evaluated supplier 20 which is subject to the learning, and acquires “the number of hits” on the search engine as the number of appearances.

The number-of-appearances acquisition unit 105 notifies the model generation unit 106 of the number of appearances of each acquired keyword.

Next, in step S15, the model generation unit 106 generates the regression model by using the evaluation value of the evaluated supplier 20 being subject to the learning, and the number of appearances as to the evaluated supplier 20 being subject to the learning, of each keyword.

The model generation unit 106 reads from the acquired-evaluation-value storage unit 108, the evaluation value of the evaluated supplier 20 being subject the learning. Further, the model generation unit 106 acquires from the number-of-appearances acquisition unit 105, the number of appearances as to the evaluated supplier 20 being subject to the learning, of each keyword.

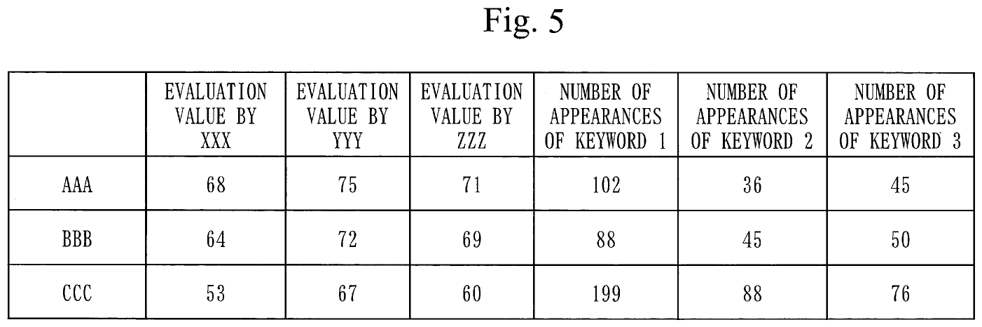

For example, the model generation unit 106, as illustrated in FIG. 5, acquires the evaluation value of the evaluated supplier 20 being subject to the learning, and the number of appearances as to the evaluated supplier 20 being subject to the learning, of each keyword.

FIG. 5 illustrates an AAA company, a BBB company, and a CCC company as the evaluated suppliers 20 which are subject to the learning.

Further, in FIG. 5, evaluation values of each of the AAA company, the BBB company, and the CCC company by an evaluation institution XXX, an evaluation institution YYY, and an evaluation institution ZZZ are illustrated.

Further, FIG. 5 illustrates the numbers of appearances of a keyword 1, a keyword 2, and a keyword 3 for each of the AAA company, the BBB company, and the CCC company.

As illustrated in FIG. 5, the model generation unit 106 generates the regression models, using the evaluation values by a plurality of evaluation institutions 40 as to a plurality of evaluated suppliers 20 being subject to the learning, and the numbers of appearances as to the plurality of evaluated suppliers 20 being subject to the learning, of a plurality of keywords.

Specifically, in a multiple regression equation (equation 1) below, the model generation unit 106 obtains for each evaluation institution 40, a value of each of partial regression coefficients β₀, β₁, β₂, and β₃ by a least-squares method.

The equation 1 after the value of each of the partial regression coefficients β₀, β₁, β₂, and β₃ is obtained is equivalent to the regression model.

y=β₀+β₁x₁+β₂x₂+β₃x₃ equation 1

Note that, y is the evaluation value of the supplier 20 by the evaluation institution 40. x₁ is the number of appearances as to the evaluated supplier 20 (for example, the AAA company) of the keyword 1. x₂ is the number of appearances as to the evaluated supplier 20 (for example, the AAA company) of the keyword 2. x₃ is the number of appearances as to the evaluated supplier 20 (for example, the AAA company) of the keyword 3.

That is, three multiple regression equations (equation 1) are generated for the evaluation value by the evaluation institution XXX, the evaluation value by the evaluation institution YYY, and the evaluation value by the evaluation institution ZZZ.

The model generation unit 106 stores the generated regression models in the model storage unit 111.

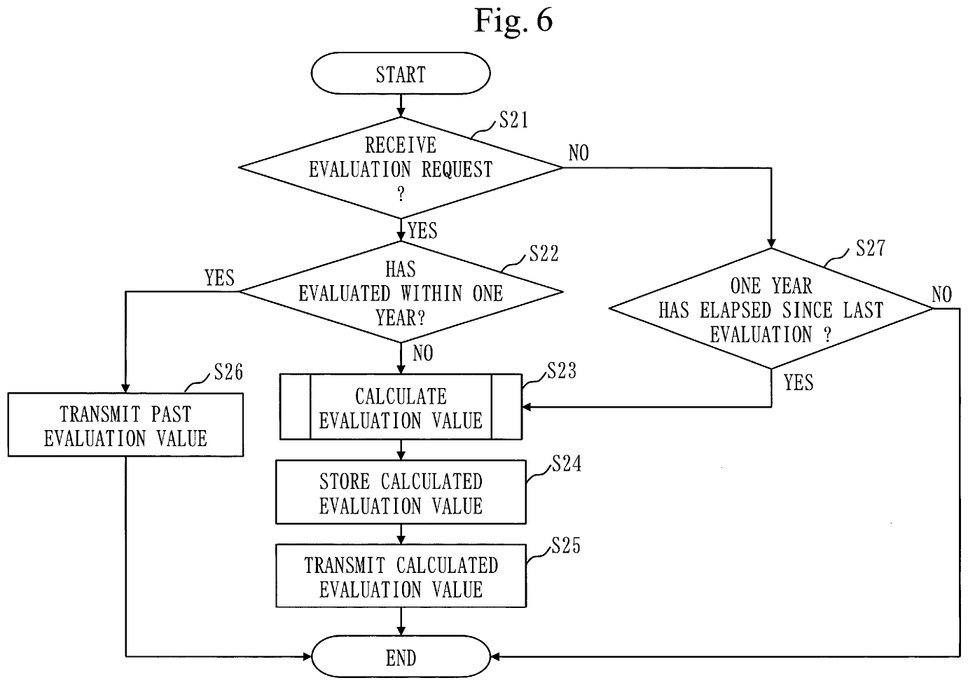

Next, with reference to FIG. 6, an operation example of the information processing apparatus 10 in the evaluation-value calculation phase will be described.

In step S21, the evaluation-value calculation unit 107 determines whether or not an evaluation request has been received from the buyer terminal device 31.

If the evaluation request has been received, the process proceeds to step S22. If the evaluation request has not been received, the process proceeds to step S27.

In step S22, the evaluation-value calculation unit 107 determines whether or not the evaluation-subject supplier 20 has been evaluated within one year.

If the evaluation-subject supplier 20 has evaluated within one year, the process proceeds to step S26. On the other hand, if the evaluation-subject supplier 20 has not been evaluated within one year, the process proceeds to step S23.

In step S23, the evaluation-value calculation unit 107 calculates the evaluation value for the evaluation-subject supplier 20, using the regression models.

Details of step S23 will be described later.

In step S24, the evaluation-value calculation unit 107 stores in the calculated-evaluation-value storage unit 112, the evaluation value of the evaluation-subject supplier 20 calculated in step S23.

Also, in step S25, the evaluation-value calculation unit 107 transmits to the buyer terminal device 31 via the communication unit 101, the evaluation value of the evaluation-subject supplier 20 calculated in step S23.

In step S26, the evaluation-value calculation unit 107 transmits to the buyer terminal device 31 via the communication unit 101, a past evaluation value of the evaluation-subject supplier 20.

Specifically, the evaluation-value calculation unit 107 reads the evaluation value of the evaluation-subject supplier 20 from the calculated-evaluation-value storage unit 112, and transmits the read evaluation value to the buyer terminal device 31 via the communication unit 101.

In step S27, the evaluation-value calculation unit 107 determines whether or not one year has elapsed since the last evaluation.

If one year has elapsed since the last evaluation, the process proceeds to step S23. On the other hand, if one year has not elapsed since the last evaluation, the evaluation-value calculation unit 107 ends the process.

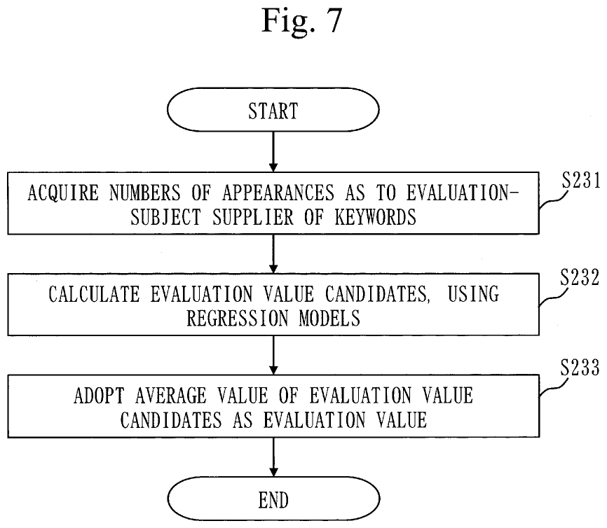

Next, with reference to FIG. 7, details of steps S23 of FIG. 6 will be described.

In step S231, the number-of-appearances acquisition unit 105 acquires the numbers of appearances as to the evaluation-subject supplier 20 of the keywords.

Specifically, the evaluation-value calculation unit 107 notifies the number-of-appearances acquisition unit 105 of a name of the evaluation-subject supplier 20. Then, the number-of-appearances acquisition unit 105 reads from the keyword storage unit 109, keywords used as explanatory variables in the regression model. Then, for each keyword, the number-of-appearances acquisition unit 105 uses as search words, the keyword and the name of the evaluation-subject supplier 20, and acquires “the number of hits” on the search website as the number of appearances.

The number-of-appearances acquisition unit 105 notifies the evaluation-value calculation unit 107 of the number of appearances of each acquired keyword.

Next, in step S232, the evaluation-value calculation unit 107 applies to the regression model, the numbers of appearances as to the evaluation-subject supplier 20 of the keywords, and calculates evaluation value candidates.

Specifically, the evaluation-value calculation unit 107 acquires a plurality of regression models from the model storage unit 111. Then, the evaluation-value calculation unit 107 applies to each of the plurality of regression models, the numbers of appearances as to the evaluation-subject supplier 20 of the keywords, and calculates a plurality of evaluation value candidates.

In an example of FIG. 5, the model generation unit 106 generates a regression model of an evaluation value by the evaluation institution XXX, a regression model of an evaluation value by the evaluation institution YYY, and a regression model of an evaluation value by the evaluation institution ZZZ. Therefore, the evaluation-value calculation unit 107 acquires from the model storage unit 111, the regression model of the evaluation value by the evaluation institution XXX, the regression model of the evaluation value by the evaluation institution YYY, and the regression model of the evaluation value by the evaluation institution ZZZ.

Then, the evaluation-value calculation unit 107 applies the numbers of appearances as to the evaluation-subject supplier 20 of the keywords to the regression model of the evaluation value by the evaluation institution XXX, the regression model of the evaluation value by the evaluation institution YYY, and the regression model of the evaluation value by the evaluation institution ZZZ (substitutes the number of appearances of the keyword to each of x₁, x₂, and x₃ in the equation 1), and acquires three evaluation value candidates (y in the equation 1) from the three regression models.

Next, in step S233, the evaluation-value calculation unit 107 adopts an average value of the evaluation value candidates as a final evaluation value.

Note that, instead of step S232, the evaluation-value calculation unit 107 may adopt as the final evaluation value, one evaluation value candidate of the three evaluation value candidates from the regression model of the evaluation value by the evaluation institution XXX, the regression model of the evaluation value by the evaluation institution YYY, and the regression model of the evaluation value by the evaluation institution ZZZ.

After that, the process proceeds to step S24 of FIG. 6.

### Description of Effect of Embodiment

As described above, according to the present embodiment, it is possible to acquire the evaluation regarding the information security of the supplier.

That is, according to the present embodiment, it is possible to acquire the evaluation regarding the information security in real time even about a supplier which has not been evaluated by the evaluation institution 40.

Further, according to the present embodiment, it is possible to prevent the evaluation-subject supplier 20 from improving the evaluation dishonestly.

If the evaluation-subject supplier 20 does not disclose information intentionally, an explanatory variable of the regression model lowers since the number of appearances of the keyword lowers. As a result, the evaluation value also lowers. Further, if the evaluation-subject supplier 20 distributes false information, the false information is weakened by true information of the website information 51 and the SNS information 52. For this reason, the evaluation-subject supplier 20 cannot acquire a high evaluation value using the false information.

In the above description, an example has been described in which the keyword selection unit 104 selects the keywords to be used for the regression models from among the keywords extracted by the keyword extraction unit 103 based on the influence degrees of the keywords.

However, the keyword selection unit 104 may be omitted. In this case, the keywords extracted by the keyword extraction unit 103 are directly used for the regression model.

### Second Embodiment

In the present embodiment, mainly matters different from the first embodiment will be described.

Note that, matters not described below are the same as those in the first embodiment.

In the first embodiment, the information processing apparatus 10 generates the regression models without distinguishing between positive keywords and negative keywords. In the present embodiment, the information processing apparatus 10 distinguishes between the positive keywords and the negative keywords, and generates the regression models.

Here, the positive keyword is a keyword which expresses a preferable matter regarding the information security. The negative keyword is a keyword which expresses an unpreferable matter regarding the information security. As the positive keywords, for example, “improvement”, “update”, “patch”, and the like are considered. As the negative keywords, for example, “vulnerability”, “backdoor”, “overflow”, and the like are considered.

In the present embodiment, in step S12 of FIG. 4, the keyword extraction unit 103 extracts the keywords, distinguishing between the positive keywords and the negative keywords.

For example, the keyword extraction unit 103 may extract three or more positive keywords only. Also, the keyword extraction unit 103 may extract three or more negative keywords only. Also, the keyword extraction unit 103 may extract three or more positive keywords and three or more negative keywords. Here, an example is assumed in which the keyword extraction unit 103 extracts three or more positive keywords and three or more negative keywords.

In the present embodiment, the keyword extraction unit 103 prepares a plurality of positive keywords and a plurality of negative keywords in advance. For example, the keyword extraction unit 103 prepares twenty positive keywords and twenty negative keywords. Then, the keyword extraction unit 103 acquires the public information, counts the number of appearances of each of the positive keywords in the public information, and extracts three or more positive keywords in the descending order of the number of appearances. Similarly, the keyword extraction unit 103 acquires the public information, counts the number of appearances of each of the negative keywords in the public information, and extracts three or more negative keywords in the descending order of the number of appearances.

Then, in step S13 of FIG. 4, the keyword selection unit 104 selects two or more positive keywords and two or more negative keywords.

A specific method of selecting the keywords by the keyword selection unit 104 is as described in the first embodiment.

Further, in step S14 of FIG. 4, the number-of-appearances acquisition unit 105 acquires the number of appearances of each keyword, as to the evaluated supplier 20 being subject to the learning, using each of the positive keywords and the negative keywords.

A specific method of acquiring the numbers of appearances of the keywords by the number-of-appearances acquisition unit 105 is as described in the first embodiment.

Then, in step S15 of FIG. 4, the model generation unit 106 performs for each of the positive keywords and the negative keywords, multiple regression analysis using the evaluation value of the evaluated supplier 20 learnt, and the numbers of appearances of the keywords. Then, the model generation unit 106 generates the regression model for each of the positive keywords and the negative keywords.

In an example of FIG. 5, for the evaluation value by the evaluation institution XXX, a multiple regression equation (equation 1) where the numbers of appearances of the positive keywords are used for x₁, x₂, and x₃, and a multiple regression equation (equation 1) where the numbers of appearances of the negative keywords are used for x₁, x₂, and x₃ are generated.

Also, for each of the evaluation value by the evaluation institution YYY and the evaluation value by the evaluation institution ZZZ, two types of regression models (multiple regression equations) are generated.

A specific method of generating the regression model by the model generation unit 106 is as described in the first embodiment.

Further, in step S231 of FIG. 7, the number-of-appearances acquisition unit 105 acquires the number of appearances as to the evaluation-subject supplier 20 of each keyword, for each of the positive keywords and the negative keywords.

A specific method of acquiring the number of appearances of the keyword by the number-of-appearances acquisition unit 105 is as described in the first embodiment.

Also, in step S232 of FIG. 7, the evaluation-value calculation unit 107 calculates the evaluation value candidates, using the regression models of the positive keywords and the regression models of the negative keywords.

A specific method of calculating the evaluation value candidates by the evaluation-value calculation unit 107 is as described in the first embodiment.

Then, in step S233 of FIG. 7, the evaluation-value calculation unit 107 takes an average of the evaluation value candidates by the evaluation models of the positive keywords and evaluation value candidates by the regression models of the negative keywords, to acquire a final evaluation value.

That is, the evaluation-value calculation unit 107 adopts as the final evaluation value, an average value of six evaluation value candidates described in (1) to (3) below.

(1) an evaluation value candidate by the regression model of the positive keywords, and an evaluation value candidate by the regression model of the negative keyword, both based on the evaluation value by the evaluation institution XXX

(2) an evaluation value candidate by the regression model of the positive keywords, and an evaluation value candidate by the regression model of the negative keyword, both based on the evaluation value by the evaluation institution YYY

(3) an evaluation value candidate by the regression model of the positive keywords, and an evaluation value candidate by the regression model of the negative keyword, both based on the evaluation value by the evaluation institution ZZZ

Alternatively, the evaluation-value calculation unit 107 may adopt as the final evaluation value, one evaluation value candidate out of the six evaluation value candidates described in (1) to (3) above.

As described above, the information processing apparatus 10 according to the present embodiment generates the regression models, distinguishing between the positive keywords and the negative keywords, and calculates the evaluation value of the evaluation-subject supplier 20, distinguishing between the positive keywords and the negative keywords.

Therefore, according to the present embodiment, it is possible to acquire more accurate security evaluation.

### Third Embodiment

In the present embodiment, mainly matters different from the first embodiment will be described.

Note that, matters not described below are the same as those in the first embodiment.

In the first embodiment, the information processing apparatus 10 generates the regression models without distinguishing between positive public information and negative public information. In the present embodiment, the information processing apparatus 10 distinguishes between the positive public information and the negative public information, and generates the regression models.

Here, the positive public information is public information which does not includes a negative keyword. The negative public information is public information which includes a negative keyword. The negative keyword is as described in the second embodiment.

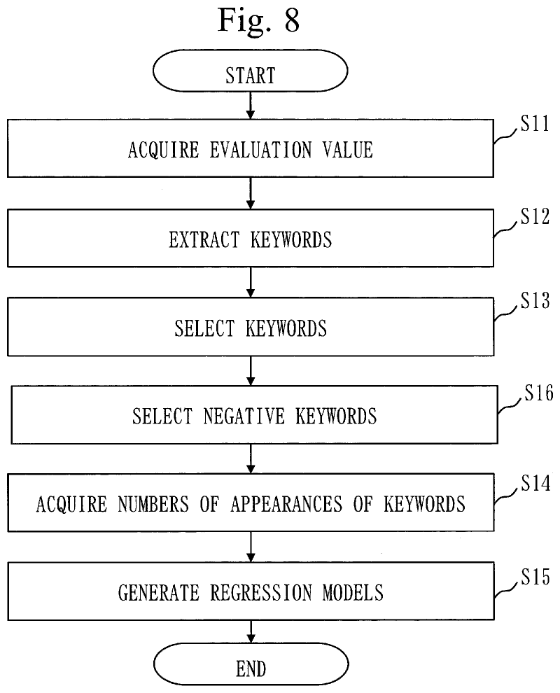

FIG. 8 illustrates an operation example of the information processing apparatus 10 in the model generation phase according to the present embodiment.

In FIG. 8, step S16 is added compared with FIG. 4. Also, due to the addition of step S16, operation different from the first embodiment is performed in steps S14 and S15.

Since steps S11 to S13 are the same as those described in the first embodiment, the descriptions will be omitted.

In step S16, the keyword selection unit 104 selects negative keywords.

Specifically, the evaluation-value calculation unit 107 prepares a plurality of negative keywords in advance. Then, the evaluation-value calculation unit 107 acquires public information, counts the number of appearances of each of the negative keywords in the public information, and selects the predetermined number of negative keywords in the descending order of the number of appearances.

Then, the evaluation-value calculation unit 107 stores the selected negative keywords in the keyword storage unit 109.

In step S14, the number-of-appearances acquisition unit 105 categorizes into the positive public information and the negative public information, the public information as to the evaluated supplier 20 which is subject to the learning. Then, the number-of-appearances acquisition unit 105 acquires the number of appearances of each keyword (a keyword used for generating the regression model) in the positive public information and the number of appearances of each keyword in the negative public information.

A specific method of acquiring the number of appearances of the keyword by the number-of-appearances acquisition unit 105 is as described in the first embodiment.

In step S15, the model generation unit 106 generates the regression model for each of the numbers of appearances of the keywords in the positive public information and the numbers of appearances of the keywords in the negative public information.

In an example of FIG. 5, for the evaluation value by the evaluation institution XXX, the multiple regression equation (equation 1) where the numbers of appearances of the keywords in the positive public information are used for x₁, x₂, and x₃, and the multiple regression equation (equation 1) where the numbers of appearances of the keywords in the negative public information are used for x₁, x₂, and x₃ are generated.

Also, for each of the evaluation value by the evaluation institution YYY and the evaluation value by the evaluation institution ZZZ, two types of regression models (multiple regression equations) are generated.

A specific method of generating the regression model by the model generation unit 106 is as described in the first embodiment.

An operation example of the information processing apparatus 10 in the evaluation-value calculation phase is as described in FIGS. 6 and 7.

Since each step described in FIG. 6 is the same as those described in the first embodiment, the descriptions will be omitted.

Below, the operation in FIG. 7 in the present embodiment will be described.

In step S231, the number-of-appearances acquisition unit 105 acquires the number of appearances as to the evaluation-subject supplier 20 of each keyword in each of the positive public information and the negative public information.

More specifically, the number-of-appearances acquisition unit 105 categorizes into the positive public information or the negative public information, the public information as to the evaluation-subject supplier 20. Then, the number-of-appearances acquisition unit 105 acquires the number of appearances of each keyword (a keyword included in the regression model) in the positive public information and the number of appearances of each keyword in the negative public information.

A specific method of acquiring the number of appearances of the keyword by the number-of-appearances acquisition unit 105 is as described in the first embodiment.

In step S232, the evaluation-value calculation unit 107 calculates the evaluation value candidates, using the regression model where the numbers of appearances of the keywords in the positive public information are used, and the regression model where the numbers of appearances of the keywords in the negative public information are used.

A specific method of calculating the evaluation value candidate by the evaluation-value calculation unit 107 is as described in the first embodiment.

In step S233, the evaluation-value calculation unit 107 takes an average of the evaluation value candidates by the regression models where the numbers of appearances of the keywords in the positive public information are used, and the evaluation value candidates by the regression models where the numbers of appearances of the keywords in the negative public information are used, to acquire a final evaluation value.

That is, the evaluation-value calculation unit 107 adopts as the final evaluation value, an average value of six evaluation value candidates described in (1) to (3) below.

(1) an evaluation value candidate by the regression model where the numbers of appearances of the keywords in the positive public information are used, and an evaluation value candidate by the regression model where the numbers of appearances of the keywords in the negative public information are used, both based on the evaluation value by the evaluation institution XXX

(2) an evaluation value candidate by the regression model where the numbers of appearances of the keywords in the positive public information are used, and an evaluation value candidate by the regression model where the numbers of appearances of the keywords in the negative public information are used, both based on the evaluation value by the evaluation institution YYY

(3) an evaluation value candidate by the regression model where the numbers of appearances of the keywords in the positive public information are used, and an evaluation value candidate by the regression model where the numbers of appearances of the keywords in the negative public information are used, both based on the evaluation value by the evaluation institution ZZZ

Alternatively, the evaluation-value calculation unit 107 may adopt as the final evaluation value, one evaluation value candidate out of the six evaluation value candidates described in (1) to (3) above.

As described above, the information processing apparatus 10 according to the present embodiment generates the regression models, distinguishing between the positive public information and the negative public information, and calculates the evaluation value of the evaluation-subject supplier 20, distinguishing between the positive public information and the negative public information.

Therefore, according to the present embodiment, it is possible to acquire more accurate security evaluation.

In the above description, an example has been described in which the public information which does not include the negative keyword is treated as the positive public information and the public information which includes the negative keyword is treated as the negative public information. Alternatively, the public information which does not include the positive keyword may be treated as the negative public information, and the public information other than the negative public information may be treated as the positive public information.

Also, a regression equation which categorizes the public information into the positive public information and the negative public information may be acquired based on machine learning.

In this case, teacher data is prepared where a keyword included in the public information is an explanatory variable and a result of categorizing of the positive public information and the negative public information is an object variable. Note that, the categorizing of the positive public information and the negative public information is performed manually.

Then, based on the machine learning using the teacher data, the regression equation which categorizes the public information into the positive public information and the negative public information is obtained.

After the regression equation above is obtained, in step S14 of FIG. 4, the number-of-appearances acquisition unit 105 applies to the regression equation, the keywords included in the public information to be categorized, and categorizes into one of the positive public information and the negative public information, the public information to be categorized.

Further, in step S231 of FIG. 7, the number-of-appearances acquisition unit 105 applies to the regression equation, the keywords included in the public information to be categorized, and categorizes into one of the positive public information and the negative public information, the public information to be categorized.

By using the regression equation obtained based on the machine learning, it is possible to categorizes the public information into the positive public information or the negative public information more accurately.

Although the first to third embodiments have been described above, two or more of these embodiments may be combined and implemented.

Alternatively, one of these embodiments may be partially implemented.

Alternatively, two or more of these embodiments may be partially combined and implemented.

Note that, configurations and procedures described in these embodiments may be modified as necessary.

***Supplementary Description of Hardware Configuration***

Finally, supplementary descriptions of the hardware configuration of the information processing apparatus 10 will be given.

The processor 901 illustrated in FIG. 2 is an IC (Integrated Circuit) that performs processing.

The processor 901 is a CPU (Central Processing Unit), a DSP (Digital Signal Processor), or the like.

The main storage device 902 illustrated in FIG. 2 is a RAM (Random Access Memory).

The auxiliary storage device 903 illustrated in FIG. 2 is a ROM (Read Only Memory), a flash memory, an HDD (Dard Disk Drive), or the like.

The communication device 904 illustrated in FIG. 2 is an electronic circuit that executes a communication process of data.

The communication device 904 is, for example, a communication chip or an NIC (Network Interface Card).

Further, the auxiliary storage device 903 also stores an OS (Operating System).

Then, at least a part of the OS is executed by the processor 901.

While executing at least the part of the OS, the processor 901 executes the programs that realize the functions of the communication unit 101, the evaluation-value acquisition unit 102, the keyword extraction unit 103, the keyword selection unit 104, the number-of-appearances acquisition unit 105, the model generation unit 106, and the evaluation-value calculation unit 107.

By the processor 901 executing the OS, task management, memory management, file management, communication control, and the like are performed.

Further, at least one of information, data, a signal value, and a variable value that indicate results of processes of the communication unit 101, the evaluation-value acquisition unit 102, the keyword extraction unit 103, the keyword selection unit 104, the number-of-appearances acquisition unit 105, the model generation unit 106, and the evaluation-value calculation unit 107 is stored in at least one of the main storage device 902, the auxiliary storage device 903, and a register and a cash memory in the processor 901.

Further, the programs that realize the functions of the communication unit 101, the evaluation-value acquisition unit 102, the keyword extraction unit 103, the keyword selection unit 104, the number-of-appearances acquisition unit 105, the model generation unit 106, and the evaluation-value calculation unit 107 may be stored in a portable recording medium such as a magnetic disk, a flexible disk, an optical disc, a compact disc, a Blu-ray (registered trademark) disc, or a DVD. Further, the portable recording medium storing the programs that realize the functions of the communication unit 101, the evaluation-value acquisition unit 102, the keyword extraction unit 103, the keyword selection unit 104, the number-of-appearances acquisition unit 105, the model generation unit 106, and the evaluation-value calculation unit 107 may be distributed.

Further, “unit” of the communication unit 101, the evaluation-value acquisition unit 102, the keyword extraction unit 103, the keyword selection unit 104, the number-of-appearances acquisition unit 105, the model generation unit 106, and the evaluation-value calculation unit 107 may be read as “circuit”, “step”. “procedure”, or “process”.

Further, the information processing apparatus 10 may be realized by a processing circuit. The processing circuit is, for example, a logic IC (Integrated Circuit), a GA (Gate Array) an ASIC (Application Specific Integrated Circuit), or an FPGA (Field-Programmable Gate Array).

Note that, in the present specification, a superordinate concept of the processor and the processing circuit is referred to as “processing circuitry”.

That is, each of the processor and the processing circuit is a specific example of the “processing circuitry”.

### REFERENCE SIGNS LIST

10: information processing apparatus, 20: supplier, 30: buyer, 31: buyer terminal device, 40: evaluation institution, 41: evaluation institution server device, 50: Internet, 51: website information, 52: SNS information, 101: communication unit, 102: evaluation-value acquisition unit, 103: keyword extraction unit, 104: keyword selection unit, 105: number-of-appearances acquisition unit, 106: model generation unit, 107: evaluation-value calculation unit, 108: acquired-evaluation-value storage unit, 109: keyword storage unit, 110: number-of-appearances storage unit, 111: model storage unit, 112: calculated-evaluation-value storage unit, 901: processor, 902: main storage device, 903: auxiliary storage device, 904: communication device, 1000: security level verification system.

1. An information processing apparatus comprising:
processing circuitry
to acquire an evaluation value regarding information security of an evaluated supplier which has been evaluated regarding the information security;
to acquire the number of appearances as to the evaluated supplier of each of two or more keywords regarding the information security in public information; and
to perform multiple regression analysis using the evaluation value of the evaluated supplier and the number of appearances as to the evaluated supplier of each of the two or more keywords in the public information, and generate a regression model whose explanatory variable is the number of appearances of each of the two or more keywords in the public information and whose object variable is the evaluation value.

2. The information processing apparatus according to claim 1, wherein
the processing circuitry
selects, based on an influence degree of each of three or more keywords regarding the information security in the public information, the two or more keywords from among the three or more keywords, and
acquires the number of appearances as to the evaluated supplier of each of the two or more keywords selected.

3. The information processing apparatus according to claim 1, wherein
the processing circuitry applies to the regression model, the number of appearances as to an evaluation-subject supplier being subject to evaluation, of each of the two or more keywords in the public information, and calculates an evaluation value of the evaluation-subject supplier.

4. The information processing apparatus according to claim 3, wherein
when calculation of an evaluation value of the evaluation-subject supplier is requested, and when the evaluation value of the evaluation-subject supplier has been calculated within a predetermined period of time, the processing circuitry outputs the calculated evaluation value to a requester.

5. The information processing apparatus according to claim 3, wherein
when an evaluation value of the evaluation-subject supplier has not been calculated within a predetermined period of time, the processing circuitry calculates the evaluation value of the evaluation-subject supplier.

6. The information processing apparatus according to claim 1, wherein
the processing circuitry
acquires at least one of the number of appearances as to the evaluated supplier of each of two or more positive keywords in the public information and the number of appearances as to the evaluated supplier of each of two or more negative keywords in the public information, and
performs multiple regression analysis using the evaluation value of the evaluated supplier, and at least of one of the number of appearances as to the evaluated supplier of each of the two or more positive keywords in the public information and the number of appearances as to the evaluated supplier of each of the two or more negative keywords in the public information, and generates the regression model.

7. The information processing apparatus according to claim 1, wherein
the processing circuitry
acquires at least one of the number of appearances of each of the two or more keywords in public information being positive about the evaluated supplier and the number of appearances of each of the two or more keywords in public information being negative about the evaluated supplier, and
performs multiple regression analysis using the evaluation value of the evaluated supplier, and at least one of the number of appearances of each of the two or more keywords in the public information being positive about the evaluated supplier and the number of appearances of each of the two or more keywords in the public information being negative about the evaluated supplier, and generates the regression model.

8. An information processing method comprising:
acquiring an evaluation value regarding information security of an evaluated supplier which has been evaluated regarding the information security;
acquiring the number of appearances as to the evaluated supplier of each of two or more keywords regarding the information security in public information; and
performing multiple regression analysis using the evaluation value of the evaluated supplier and the number of appearances as to the evaluated supplier of each of the two or more keywords in the public information, and generating a regression model whose explanatory variable is the number of appearances of each of the two or more keywords in the public information and whose object variable is the evaluation value.

9. A non-transitory computer readable medium storing an information processing program which causes a computer to execute:
an evaluation-value acquisition process of acquiring an evaluation value regarding information security of an evaluated supplier which has been evaluated regarding the information security;
a number-of-appearances acquisition process of acquiring the number of appearances as to the evaluated supplier of each of two or more keywords regarding the information security in public information; and
a model generation process of performing multiple regression analysis using the evaluation value of the evaluated supplier and the number of appearances as to the evaluated supplier of each of the two or more keywords in the public information, and generating a regression model whose explanatory variable is the number of appearances of each of the two or more keywords in the public information and whose object variable is the evaluation value.
